(19) United States
(12) Patent Application Publication
(10) Pub. No.: US 2026/0245144 A1
(43) Pub. Date: Aug. 20, 2026

(54) System and Method for Multi-Asset Based Revolving Credit and Integrated Credit Card Payment Solutions

(71) Applicant: Jacob Gottfried, Peachtree Corners, GA (US)

(72) Inventor: Jacob Gottfried, Peachtree Corners, GA (US)

(21) Appl. No.: 19/056,394

(22) Filed: Feb. 18, 2025

(51) Int. Cl. G06Q 40/03

(52) U.S. Cl. CPC G06Q 40/03

(57) ABSTRACT

This invention provides a system and method for establishing a single revolving credit facility secured by diverse asset classes. The structure of this method intends to shift risk from the lending institution to uncapitalized assets of the borrower, while lowering interest rates for the borrower. The revolving nature of the credit facility allows for flexible repayment of funds for multi-purpose use cases. The invention dynamically evaluates pledged assets using AI-driven or formulaic risk assessments. Borrowers can access funds through a linked credit card or other methods such as direct transfer, maintaining liquidity without asset liquidation. The platform continuously monitors collateral values, adjusting credit availability accordingly to optimize borrowing costs and mitigate risk. Additionally, the system monitors assets with existing loans, factoring in outstanding balances to determine net equity before establishing borrowing limits.

### BACKGROUND OF THE INVENTION

The present invention relates to a system and method for asset-based revolving credit lines with an integrated credit card payment solution that allows borrowers to leverage a broad range of assets, both traditional and non-traditional, to secure a flexible credit facility. Conventional credit systems typically rely on either unsecured credit or narrowly defined secured lending (e.g., mortgage loans, auto loans), limiting the accessibility and affordability of credit. The invention addresses these limitations by enabling individuals and businesses to pledge a diverse array of assets—including real estate, vehicles, brokerage accounts, art, cryptocurrencies, and other traditional or non-traditional assets—as collateral for a single revolving credit line. This system provides borrowers with lower interest rates, improved financial flexibility, and optimized asset utilization. Additionally, this system provides decreased capital requirements for lending institutions under Basel regulations, improving capital efficiency while maintaining risk-adjusted lending practices.

### SUMMARY OF THE INVENTION

The invention provides a financial platform that enables the establishment of an asset-based revolving credit facility by utilizing a dynamic collateral valuation model. This provides an advantage over lending that typically varies in terms and product by the asset type used as collateral (HELOC, SBLOC, etc.) and does not offer a standard comprehensive collateral function. The system evaluates, tracks, and adjusts the value of pledged assets on an ongoing basis, allowing users to maintain liquidity without selling assets. The method includes:
1. Analyzing asset types and determining eligibility and collateral contribution based on risk assessment models.
2. Issuing a credit line with an interest rate and limit calculated based on asset composition, liquidity, and volatility, as well as other credit factors.
3. Allowing borrowers to access funds via a linked credit card or other methods such as direct transfer.
4. Implementing automated collateral valuation and markets assessments to maintain required asset coverage ratios.
5. Monitoring assets with existing loans and adjusting available credit based on net equity after outstanding loan balances.

### DESCRIPTION OF THE INVENTION

The invention provides a novel financial instrument combining secured lending principles with a revolving credit structure. The system is intended to be accessible in the form of a digital online banking platform. The process begins when a borrower submits assets for collateralization. These assets undergo verification and valuation through a proprietary process integrating market data, historical performance, and risk metrics. The system assigns a valuation contribution to each asset, dynamically adjusting as market conditions change.

Upon approval, the borrower receives a credit line reflecting the assessed value of their pledged assets. The system continuously monitors asset values and alerts borrowers if the collateral valuation falls below a predefined threshold, prompting additional collateral deposits or partial repayment. Funds can be accessed via a credit card linked to the revolving credit line or through other methods such as direct transfers.

The platform incorporates valuation services for assets and AI-driven or formulaic risk assessments to ensure accurate and fair valuations. Additionally, the system monitors assets that have existing loans against them, calculating the net equity by deducting outstanding loan balances from the asset's current valuation. The credit facility adjusts based on this net equity, ensuring accurate and fair borrowing limits.

1. A system and method for establishing an asset-based revolving credit facility with an integrated credit card, comprising: (a) receiving asset collateral submissions from a borrower across extensive liquid and illiquid asset types, allowing for collateralization of a single credit facility; (b) assessing asset value using market data and risk metrics; (c) assigning a collateral contribution to each asset; (d) issuing a revolving credit line based on total collateral value and risk adjusting for each asset, as well as other credit factors; (e) enabling fund access via a linked credit card or other methods such as direct transfer; (f) monitoring asset value fluctuations and adjusting credit availability accordingly; (g) evaluating net equity in assets that have existing loans and adjusting available credit based on remaining equity.

2. The method of claim 1, wherein the asset evaluation includes real estate (main residential, investment, commercial, land, etc.), vehicles (automobiles, motorcycles, boats, RVs, etc.), cash accounts, securities accounts, cryptocurrency, fine art, luxury jewelry, precious metals, gems, and any other liquid or illiquid assets deemed acceptable.

3. The method of claim 1, wherein the system uses AI-driven algorithms or formulaic calculations for continuous risk assessment and collateral valuation adjustments.

4. The method of claim 1, wherein borrowers receive notice of collateral shortfalls requiring additional deposits or repayment.
